(19) United States
(12) Patent Application Publication
(10) Pub. No.: US 2010/0318438 A1
(43) Pub. Date: Dec. 16, 2010

(54) METHOD AND APPARATUS FOR PROVIDING AN ELECTRONIC COMMERCE WEBSITE

(76) Inventors: GRAHAM CORMODE, Morristown, NJ (US); Balachander Krishnamurthy, New York, NY (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/485,148

(22) Filed: Jun. 16, 2009

(51) Int. Cl. G06Q 30/00; H04W 4/12

(52) U.S. Cl. 705/26; 705/28; 455/466

(57) ABSTRACT

A method and an apparatus for providing an electronic commerce website over a network are disclosed. For example, the method receives a request for a product or a service from a customer via an electronic commerce website, and identifies internal information pertaining to the request, wherein the internal information is information known by a business enterprise of the electronic commerce website. The method also identifies external information pertaining to the request, wherein the external information is information obtained by the business enterprise from another entity, and sends the internal information and the external information pertaining to the request to the customer.

The present invention relates generally to communication networks and, more particularly, to a method and apparatus for providing an electronic commerce (e-commerce) Website with enhanced functionalities over a network, e.g., an Internet Protocol (IP) network.

### BACKGROUND OF THE INVENTION

Businesses often have a website that allows their customers to order products and/or services electronically. The content on a business website is generally created by the owner. That is, customers may not have any say in what is posted on a business website. However, as Internet technologies are rapidly evolving, more and more customers are accustomed to interactive websites, e.g., facebook.com, myspace.com, etc. Websites that are populated by the owner for passive consumption by customers seem antiquated to some customers. Hence, e-commerce websites designed to simply present content created by the owner to potential customers (as opposed to websites that allow interaction with potential customers) are less appealing and may have a reduced amount of business.

### SUMMARY OF THE INVENTION

In one embodiment, the present invention discloses a method and an apparatus for providing an electronic commerce (e-commerce) website over a network. For example, the method receives a request for a product or a service from a customer via an electronic commerce website, and identifies internal information pertaining to the request, wherein the internal information is information known by a business enterprise of the electronic commerce website. The method also identifies external information pertaining to the request, wherein the external information is information obtained by the business enterprise from another entity, and sends the internal information and the external information pertaining to the request to the customer.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network in accordance with one embodiment of the current invention for providing an e-commerce website;

FIG. 3 illustrates a flowchart of a method for providing an electronic commerce website over a network; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing an electronic commerce (e-commerce) website with enhanced functionalities over a network. Although the present invention is discussed below in the context of Internet Protocol (IP) Multimedia Subsystem (IMS) networks, the present invention is not so limited. Namely, the present invention can be applied to packet networks in general, e.g., Voice over Internet Protocol (VoIP) networks, Service over Internet Protocol (SoIP) networks, and the like.

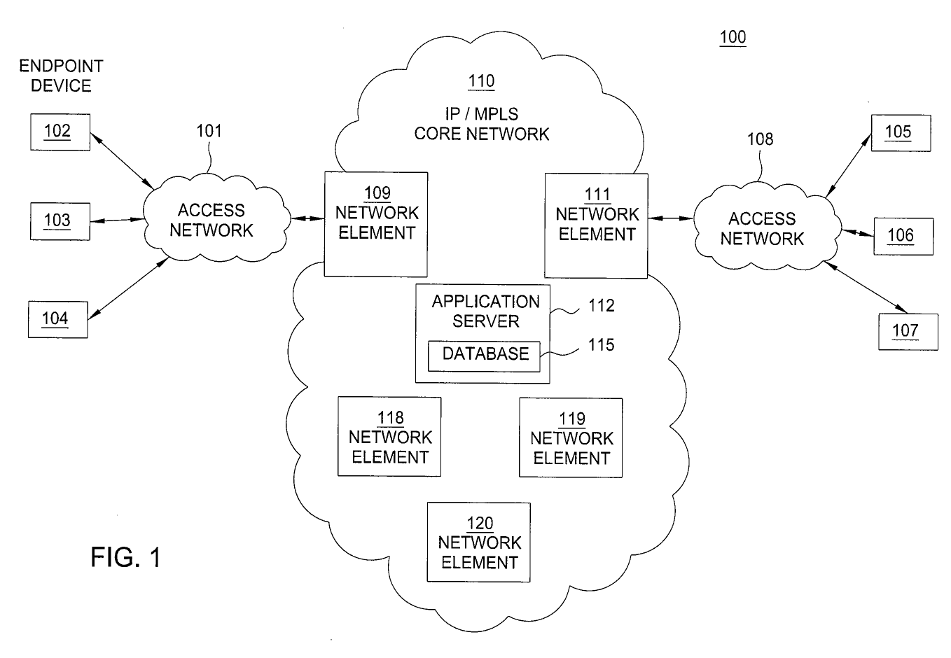

To better understand the present invention, FIG. 1 illustrates an example network 100, e.g., an Internet Protocol (IP) Multimedia Subsystem network related to the present invention. An IP network is broadly defined as a network that uses Internet Protocol to exchange data packets. Exemplary IP Multimedia Subsystem (IMS) networks include Internet protocol (IP) based networks such as Voice over Internet Protocol (VoIP) networks, Service over Internet Protocol (SoIP) networks, and the like.

In one embodiment, the network 100 may comprise a plurality of endpoint devices 102-104 configured for communication with the core IMS network 110 (e.g., an IP based core backbone network supported by a service provider) via an access network 101. Similarly, a plurality of endpoint devices 105-107 are configured for communication with the IMS core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), and the like. The access networks 101 and 108 serve as a means to establish a connection between the endpoint devices 102-107 and the Network Elements (NEs) 109 and 111 of the IMS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IMS core network 110, or indirectly through another network.

Some NEs (e.g., NEs 109 and 111) reside at the edge of the IMS core infrastructure and interface with customer endpoints over various types of access networks. An NE that resides at the edge of a core infrastructure is typically implemented as an edge router, a media gateway, a proxy, a border element, a firewall, a switch, and the like. An NE may also reside within the network (e.g., NEs 118-120) and may be used as a SIP server, a core router, or like device. The IMS core network 110 also comprises an Application Server 112 that contains a database 115.

The application server 112 may comprise any server or computer that is well known in the art, and the database 115 may be any type of electronic collection of data that is also well known in the art. Those skilled in the art will realize that the communication system 100 may be expanded by including additional endpoint devices, access networks, network elements, application servers, etc. without altering the scope of the present invention.

The above IP network is described to provide an illustrative environment in which packets for voice, data, and multimedia services are transmitted on IP Multimedia Subsystem (IMS) networks. Businesses often have a website that allows their customers to electronically conduct business transactions, e.g., order products and/or services over an IP network.

For example, customers may reach a business website using a Universal Resource Locator (URL), over an IP network. Websites based on what is informally referred to as a Web 1.0 standard (traditional sites) enable the business to create content and make the content available for consumption/access by customers. Customers may not have any means of posting content on the website. However, as Internet technologies are rapidly evolving, more and more customers have become accustomed to interactive websites that are based on Web 2.0 standards. For example, social networking websites, such as facebook.com, myspace.com, and the like allow customers a certain amount of capability to create and/or edit the content on the websites. The ease with which individual customers can create, modify, share and/or delete content on Web 2.0 based websites has raised customer expectations. Hence, websites that are based merely on Web 1.0 standard for presenting content to customers may not be appealing. Consequently, businesses with Web 1.0 based websites may be unable to meet customer expectations.

In one embodiment, the current method provides an enhanced e-commerce website that is able to provide enhanced functionalities. For example, when a customer conducts a transaction, the method first identifies internal and external information pertaining to the transaction. Internal information refers to information that is known by the business enterprise. External information refers to information obtained by the business enterprise from other entities, e.g., other businesses and/or customers.

In one embodiment, internal information may comprise order tracking information such as: status of the order (e.g., physical location of an ordered item, current processing stage of an ordered item that needs to be built), wait time of the order (e.g., if the item is back ordered, or if the ordered item needs to be built), and customer representative notes (e.g., comments and notes taken by customer representatives of the company pertaining to the ordered item when interacting with the customer, and the like).

In one embodiment, internal information may also comprise business related information (i.e., information not directly associated with a particular order) such as: sales volumes, feedback from other customers (e.g., feedback sent by customers via emails, posted in a company's website, and so on), customer behaviors such as order patterns, similar products/services suggested by other customers, product updates, manufacturer information, and so on. Broadly, internal information comprises information that is internal to a company.

In one embodiment, external information may comprise information obtained from external sources, e.g., shipping or delivery service companies (e.g., tracking number to track shipping status), news organizations, organizations that provide testing, organizations that provide qualification, organizations that employ critics who evaluate products and services, government agencies, various other external websites, a customer forum, or a blog website, etc. Broadly, external information comprises information that is external to a company, but can be obtained from one or more external sources.

In one embodiment, the method may provide the internal information and/or external information to the customer in a manner familiar to the customer as a result of the customer's experience in highly interactive websites (e.g., social networking websites). For example, the method may provide internal information and/or external information and enable the customer to provide feedback, join blogs, and so on. The customer may also be provided with links such that he/she is able to share experiences with other customers. Hence, the relationship between the business and the customer may be continued after the business transaction is completed.

In one embodiment, the method may then receive feedback from the customer on the transaction. For example, the customer may provide a review of a product/service. The customer may provide a review as to the customer's experience in interacting with the company. The customer may also provide recommendation and/or willingness to interact with other potential customers.

In one embodiment, if feedback is received from the customer, the method may then provide the received information to other customers. For example, the method may process the received feedback such that the information can be used by other customers. The method may then store the information at the website and/or transmit to customers based on their respective preference.

In one embodiment, the business may provide enhanced services or functionalities such as: sending notifications to individuals identified by the customer, sending notifications to partners and/or administrative assistants of the customer, providing links to customer feedback and/or blogs, and so on.

In one embodiment, the information provided to the customer may comprise billing information. For example, if the transaction between the customer and the business is service oriented, the business may provide bills on a predetermined schedule. The information may comprise status of bills, accrued service credits and/or rewards, etc.

In one embodiment, the business may present internal and external information to the customer over a preferred transmission medium. For example, the customer may provide preference for receiving information over one or more of: an email message, a cell phone call, a landline call, a text message, a Short Message Service (SMS) message, and so on. The customer may then be able to reach a representative of the business for further interaction, if desired. That is, the enhanced website may be used by the customer for interacting with the business and procuring a product/service in a manner similar to the experience received on social networking websites (i.e. in a manner similar to Web 2.0 based or better websites).

In one embodiment, the method presents the internal and external information using a template. For example, the method may populate the template (e.g., a shipping form, a warranty form, a return product form, a rebate form, and the like) based on previous transactions and/or interactions. For example, if the customer had purchased a similar product previously, a predetermined portion of the template may be populated based on information obtained during the previous transaction.

In one embodiment, the method may populate the template based on one or more common actions performed by other users. For example, if most customers populate certain fields of the template in a specific manner, then the method may populate these particular fields in the template in a similar fashion prior to presenting the template to the customer. The customer may then alter the information as desired by editing the information rather than filling out the entire template. In other words, a predetermined portion of the template can be populated based on information obtained from other customers, e.g., populating certain fields with predetermined entries where a very high percentage (e.g., 90% and so on) of other customers have similarly selected such predetermined entries.

In one embodiment, the method enables customers to specify the level of detail for the internal and external information that may be received from the business. For example, a customer may wish to receive information only when a product is shipped or a service is delivered, whereas another customer may wish to be informed when the order is started, when any agent touches the order, when there is any status change associated with the order, etc.

In one embodiment, the method enables customers to specify the frequency of updates of the internal and external information. For example, a customer may wish to receive updates on a weekly basis while another customer requests a daily update, an hourly update, near real time update, and the like.

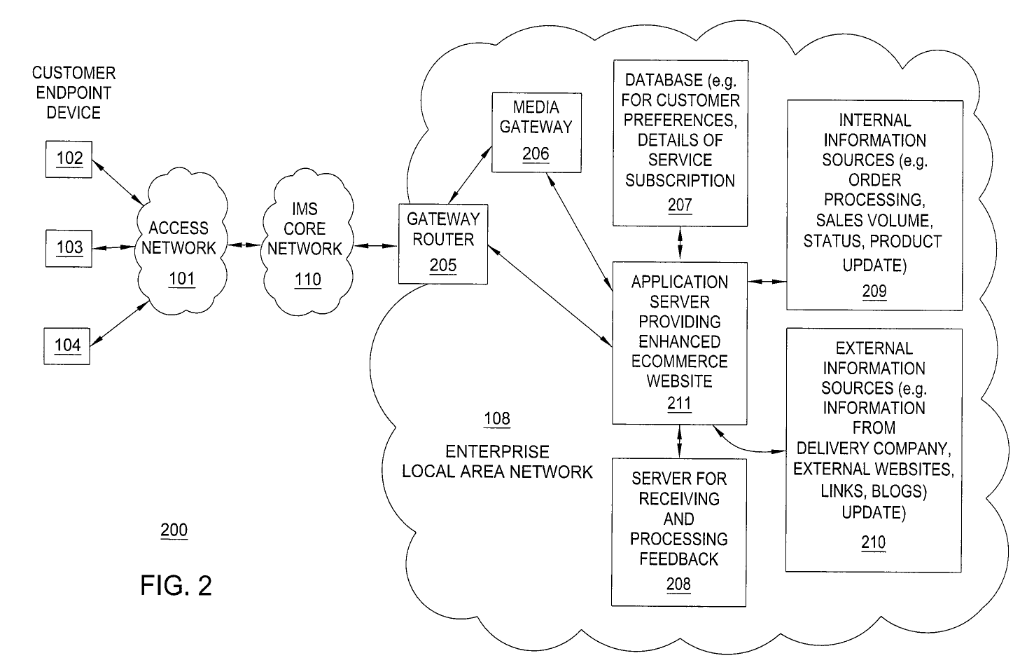

FIG. 2 illustrates an exemplary network 200 in accordance with one embodiment of the current invention for providing an e-commerce website with enhanced functionalities. In one embodiment, the network 200 comprises customer endpoint devices 102-104 communicating with an enterprise LAN 108, over an access network 101 and an IMS core network 110. In one embodiment, the LAN 108 comprises a gateway router 205, a media gateway 206, a database 207, a server 208 for receiving and processing feedback, one or more internal information sources 209, one or more external information sources 210, and an application server 211 for hosting the enterprise's enhanced e-commerce website (e.g., the business website). It should be noted that the one or more internal information sources 209 and the one or more external information sources 210 can be implemented as databases or servers that have such internal and external information stored locally within the enterprise local area network, or alternately, they can be implemented as servers that have the ability to acquire the information from another location or source. In turn, the application server 211 is in communication with the gateway router 205, media gateway 206, database 207, server 208, internal information sources 209 and external information sources 210.

In one embodiment, the gateway router 205 is used for routing packets to/from LAN 108 via the IMS core network 110. The media gateway 206 may be used for communicating with various customer endpoint devices in a format compatible with the devices. The media gateway 206 may also be used to provide information to customers in a preferred format, standard, and so on.

In one embodiment, the database 207 may be used to store customer preferences and details of the service that a customer has subscribed (e.g., stored in a customer profile). For example, a customer may prefer communication to be via email, SMS, a phone call, etc. In another example, the customer may prefer information to be presented in a pre-populated template. In another example, a customer may subscribe to other enhancement of services such as sending order and/or status information to associates, colleagues, assistants, etc. The current method for providing an enhanced e-commerce website may then be implemented in an application server 211.

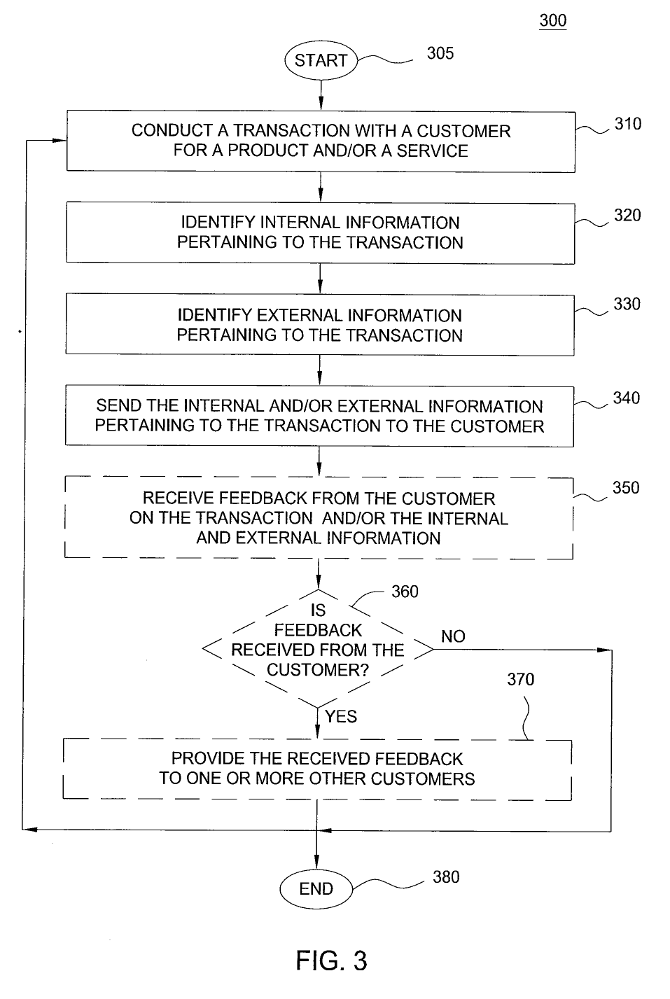

FIG. 3 illustrates a flowchart of a method 300 for providing an e-commerce website over a network. For example, one or more steps of method 300 can be implemented in an application server hosting an e-commerce website for a business (or an enterprise). Method 300 starts in step 305 and proceeds to step 310.

In step 310, method 300 conducts a transaction with a customer for a product and/or a service (broadly request a request for a product or a service). For example, a customer visits a website and subscribes to a service or orders a product.

In step 320, method 300 identifies internal information pertaining to the transaction, wherein internal information is information known by a business enterprise. For example, the method may identify sales volume, current status of the transaction, billing information, and so on.

In step 330, method 300 identifies external information pertaining to the transaction, wherein the external information is information obtained by the business enterprise from another entity. For example, the method may identify external information such as delivery status by a shipping company, similar products, known customer forums, blogs, etc. It should be noted that the step of identify external information pertaining to the transaction is not limited to a onetime event. In other words, step 330 can be a continual operation that can be performed long after the transaction is completed.

In step 340, method 300 sends the internal and/or external information pertaining to the transaction to the customer. For example, the method may send sales volume, current status of transaction, delivery status, information about forums/blogs, etc. to the customer in a manner familiar to the customer as the result of the customer's experience in highly interactive websites (e.g. social networking websites).

It should be noted that sending the internal and external information directly to the customers does not encompass providing a link so that the customers can then acquire the information themselves. In fact, sending a link so that a customer can acquire the information himself does not fall within the scope of the present invention. More specifically, the present invention discloses a method wherein external information that is readily available to the customer is actively acquired on behalf of the customer and then delivered to the customer in the context of fulfilling a transaction with the customer.

In optional step 350, method 300 receives feedback from the customer on the transaction and/or internal and external information. For example, the customer may provide a review of a product/service. The customer may also provide recommendation and/or willingness to interact with other potential customers.

In optional step 360, method 300 determines if feedback is received from the customer. If feedback is received, then the method proceeds to step 370. Otherwise, the method ends in step 380 or returns to step 310 to continue conducting transactions.

In optional step 370, method 300 provides the received feedback to one or more other customers. For example, the method may process the received feedback such that the information may be used by the customer and/or other customers. The method may then store the information at the website and/or transmit to customers based on their respective preference. The method then ends in step 380 or returns to step 310 to continue conducting transactions.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

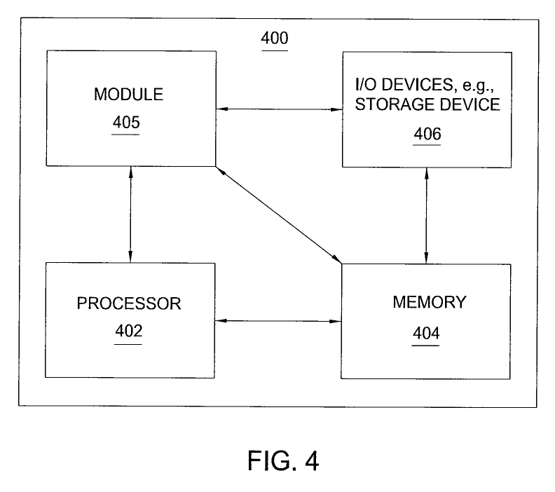

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing an electronic commerce (e-commerce) website with enhanced functionalities, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing an electronic commerce (e-commerce) website with enhanced functionalities can be loaded into memory 404 and executed by processor 402 to implement the functions as discussed above. As such, the present method 405 for providing an electronic commerce (e-commerce) website with enhanced functionalities (including associated data structures) of the present invention can be stored on a computer readable storage medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing an electronic commerce website over a network, comprising:
receiving a request for a product or a service from a customer via the electronic commerce website;
identifying internal information pertaining to said request, wherein said internal information is information known by a business enterprise of said electronic commerce website;
identifying external information pertaining to said request, wherein said external information is information obtained by said business enterprise from another entity; and
sending said internal information and said external information pertaining to said request to said customer.

2. The method of claim 1, further comprising:
receiving a feedback from said customer on at least one of: said request, said internal information, or said external information; and
providing said feedback to one or more other customers.

3. The method of claim 1, wherein said internal information comprises order tracking information.

4. The method of claim 1, wherein said internal information comprises business related information.

5. The method of claim 1, wherein said external information comprises information obtained from at least one of: a shipping service company, a news organization, an organization that provides testing, an organization that provides qualification, an organization that evaluates a product or a service, a government agency, an external website, a customer forum, or a blog website.

6. The method of claim 1, wherein said sending said internal information and said external information to said customer is performed over a transmission medium selected by said customer.

7. The method of claim 6, wherein said transmission medium comprises at least one of: an email message, a cell phone call, a landline call, a text message, or a Short Message Service (SMS) message.

8. The method of claim 1, wherein said sending said internal information and said external information to said customer is performed using a template, wherein said template is populated in part based on at least one of: one or more transactions of said customer, or common actions performed by one or more other customers.

9. The method of claim 1, wherein said customer specifies a level of detail for receiving said internal information and said external information.

10. A computer-readable medium having stored thereon a plurality of instructions, the plurality of instructions including instructions which, when executed by a processor, cause the processor to perform a method for providing an electronic commerce website over a network, comprising:
receiving a request for a product or a service from a customer via the electronic commerce website;
identifying internal information pertaining to said request, wherein said internal information is information known by a business enterprise of said electronic commerce website;
identifying external information pertaining to said request, wherein said external information is information obtained by said business enterprise from another entity; and
sending said internal information and said external information pertaining to said request to said customer.

11. The computer-readable medium of claim 10, further comprising:
receiving a feedback from said customer on at least one of: said request, said internal information, or said external information; and
providing said feedback to one or more other customers.

12. The computer-readable medium of claim 10, wherein said internal information comprises order tracking information.

13. The computer-readable medium of claim 10, wherein said internal information comprises business related information.

14. The computer-readable medium of claim 10, wherein said external information comprises information obtained from at least one of: a shipping service company, a news organization, an organization that provides testing, an organization that provides qualification, an organization that evaluates a product or a service, a government agency, an external website, a customer forum, or a blog website.

15. The computer-readable medium of claim 10, wherein said sending said internal information and said external information to said customer is performed over a transmission medium selected by said customer.

16. The computer-readable medium of claim 15, wherein said transmission medium comprises at least one of: an email message, a cell phone call, a landline call, a text message, or a Short Message Service (SMS) message.

17. The computer-readable medium of claim 10, wherein said sending said internal information and said external information to said customer is performed using a template, wherein said template is populated in part based on at least one of: one or more transactions of said customer, or common actions performed by one or more other customers.

18. The computer-readable medium of claim 10, wherein said customer specifies a level of detail for receiving said internal information and said external information.

19. An apparatus for providing an electronic commerce website over a network, comprising:
means for receiving a request for a product or a service from a customer via the electronic commerce website;
means for identifying internal information pertaining to said request, wherein said internal information is information known by a business enterprise of said electronic commerce website;
means for identifying external information pertaining to said request, wherein said external information is information obtained by said business enterprise from another entity; and
means for sending said internal information and said external information pertaining to said request to said customer.

20. The apparatus of claim 19, further comprising:
means for receiving a feedback from said customer on at least one of: said request, said internal information, or said external information; and
means for providing said feedback to one or more other customers.
